(19) United States
(12) Patent Application Publication
(10) Pub. No.: US 2019/0291147 A1
(43) Pub. Date: Sep. 26, 2019

(54) METHOD AND APPARATUS FOR WASHING TRADES EQUIPMENT

(71) Applicant: Geosentinel Pty Ltd., Arcadia NSW (AU)

(72) Inventor: Andrew CRIMSTON, Arcadia NSW (AU)

(21) Appl. No.: 16/308,255

(22) PCT Filed: Jun. 8, 2017
(86) PCT No.: PCT/AU2017/050573

§ 371 Date: Dec. 7, 2018

(30) Foreign Application Priority Data
Jun. 10, 2016 (AU) 2016902276

(51) Int. Cl. B08B 3/14; B08B 3/10; B08B 3/02; C02F 1/00; C02F 1/52

(52) U.S. Cl. CPC B08B 3/14; B08B 3/102; B08B 3/02; B08B 9/032; C02F 1/52; B08B 2203/0223; C02F 1/001

(57) ABSTRACT

A method of washing trades equipment comprising directing a wash fluid in a substantially clean state supplied from a supply tank by a first pump through a nozzle, at the equipment. Collecting the now contaminated wash fluid within a receptacle into a collection tank positioned above the supply tank. The wash fluid in the collection tank dosed by a coagulant is allowed to separate into relatively clean wash fluid above a layer of sediment in the collection tank, and at least a portion of the relatively clean wash fluid in said collection tank is discharged into the supply tank under the influence of gravity. Periodically a second pump is used to pump sediment and wash fluid to a filter assembly and that under the influence of gravity wash fluid passes through the filter assembly thereby by leaving behind a substantially de-watered sediment in the filter assembly,

### TECHNICAL FIELD

The present invention relates to a washing apparatus and method for washing contaminated trade tools and other equipment. The present invention is primarily described with reference to an apparatus and method for washing painting equipment such as paint brushes, paint rollers, spray gun nozzles and fittings, paint trays and the like. However, it should be understood that the washing apparatus and method of the present invention could be used to wash other trades equipment, such as that used by concreters, tilers, renderers, plasterboard installers and the like.

### BACKGROUND

When a painting task is finished or at the end of a working day, many painters clean their tools of the trade such as paint brushes, paint rollers, spray guns, or other equipment, with a water hose in a basin. The water contaminated with waste from the equipment (the water in this Is contaminated state is known as “wash-water”) typically drains from the basin into the sewer or onto the ground. This practice is both detrimental to the environment and a waste of water.

In some jurisdictions it is illegal to allow wash-water used to clean paint equipment and other trades equipment into the sewer. Accordingly professional painters, building sites and the like who generate large amounts of wash-water, employ third party contractors to remove and dispose of wash-water in an environmentally friendly manner. As it is quite expensive to handle such contaminated wash-water, a number of prior art devices and systems are known to separate waste from wash-water, thereby allowing contractors to only cart the waste away from site, and possibly allow for the recycling of the treated water.

One such prior art system is described in AU2004100677 (Enviro Solutions Pty Ltd). This system utilises a basin (upper wash structure) in which paint equipment is washed. A settlement tank is disposed below the basin and is used to catch wash-water. A flocculant is added to the settlement tank for the purposes of separating the wash-water into a sediment of paint solids and relatively clean water. The separation process may take up to 24 hours and results in sediment at the bottom of the settlement tank that may be drawn off for disposal, whilst the separated water may be re-used.

A disadvantage of this prior art system is that a substantial amount of time must pass before the water in the collection tank can be re-used, due to the time it takes for the waste to settle out of the wash-water.

Another prior art system is described in WO 2010/022455 (Geosentinel Pty Ltd). This apparatus uses at least three tanks so that wash-water collected in one of the tanks may settle by means of flocculant added to the tank, whilst the other two tanks are used to supply clean water and collect wash-water. This allows washing to continue whilst the waste settles out of the water in the first tank. This system overcomes the problem of the system as described in AU2004100677 in that it can operate continuously by switching between tanks. However, a disadvantage of this system is that the three tank arrangement results in the system being relatively large and complex. Furthermore, this system still relies on significant settlement time before the water collected in any particular tank can be re-used, which may be an issue if one of the other tanks is emptied of clean water before settlement is completed.

To assist in separating out the waste held in suspension in the wash-water an additive may be added. The additive may be a “flocculant”, as mentioned above, or a “coagulant”. Coagulants clump, or coalesce, fine waste particles together into larger particles that are still relatively small (these particles are known as “pin floc”). Flocculants clump the fine waste particles into larger solids than produced by coagulants, and these larger solids settle out.

Another prior art system is described in WO 2012/024729 (Geosentinel Pty Ltd). In this arrangement the apparatus comprises a dosing device for introducing a coagulant into the wash fluid. In this arrangement wash fluid is pumped by a return pump from the collection tank to the supply tank via a return filter system. One disadvantage is that any waste not being captured by the return filter system, either due to particle size, or damaged filter results in waste entering the supply tank.

One disadvantage common to the above mentioned prior art is that sediment/solid waste that is settled out or captured in filters and the like still has a significant volume of water mixed with it. This makes the sediment/solid waste in the form of a sludge or slurry, which may have a considerable weight due to the presence of water. This means that a contractor is typically required to cart the waste away from site. This contractor is faced with additional costs regarding material handling of the waste, and possible occupational health and safety issues due to the weight of the waste.

The present invention seeks to overcome at least one of the disadvantages of the prior art.

### SUMMARY OF INVENTION

In a first aspect the present invention consists of a washing apparatus for washing trades equipment, the apparatus comprising:
a supply tank containing a wash fluid in a substantially clean state;
a supply pump for supplying the wash fluid from the supply tank through a first line to at least one nozzle for directing the wash fluid at the equipment;
at least one receptacle for collecting the wash fluid in a contaminated state, the wash fluid being contaminated with waste washed from the equipment;
a collection tank for holding the wash fluid collected by said receptacle, said collection tank positioned substantially above said supply tank and in fluid connection there between via a second line having a first valve;
a dosing device for automatically introducing a coagulant into the wash fluid within said collection tank; and
a return pump for pumping the contaminated wash fluid and sediment from the collection tank to at least one filter assembly fluidally connected via a third line to said collection tank, characterised in that an agitator is disposed within said collection tank for agitating said wash fluid and said sediment, said return pump cyclically urges said sediment and contaminated wash fluid to said filter assembly, and that under influence of gravity wash fluid passes through said filter assembly and returns to said collection tank thereby leaving behind a substantially de-watered sediment in said filter assembly, and once said wash water in said collection tank has under the influence of said coagulant formed relatively clean water above a layer of said sediment, at least portion of said relatively clean water may be discharged under influence of gravity to said supply tank via said first valve in said second line.

Preferably said supply tank is fluidally connected to said return pump via a fourth line having a second valve so that wash water in said supply tank can be pumped through said filter assembly.

Preferably said filter assembly is disposed at a location above said collection tank, and said apparatus comprises a platform and a step which allows a user to step up to said platform and access said filter assembly.

Preferably an electronic control unit operably connected to said supply pump, return pump, said first valve, and an upper level switch within said collection tank, said electronic unit comprising a plurality of timers.

Preferably when said collection tank is filled and said level switch is actuated, the power to both said supply pump and said return pump is cut-off for a first period of time to allow wash water in said collection tank under the influence of said coagulant to form relatively clean water above a layer of said sediment, and following said first period of time, said first valve is electronically actuated to open for a second period of time to allow at least portion of said relatively clean water to be discharged under influence of gravity to said supply tank.

Preferably said return pump is periodically actuated by said electronic control unit to flush said third line and provide regular filtration to said wash water.

Preferably said electronic control unit is able to control said apparatus through a first working cycle and second standby cycle.

Preferably said washing apparatus comprises a first visual indicator, a second visual indicator and a third visual indicator, all operably connected to said electronic control unit, said first visual indicator for indicating that said apparatus may be used during said working cycle, said second visual indicator for indicating that said apparatus cannot be used during said work cycle as said collection tank is full.

Preferably during said second standby cycle, and subsequent to at least portion of said relatively clean water being discharged under influence of gravity to said supply tank, said return pump is periodically operated to pump a slurry of said sediment to said filters, and at a later time said return pump is deactivated to allow for dewatering of the slurry in said filters in order to allow for change of said filters.

Preferably said agitator is operated simultaneously with said return pump.

Preferably said agitator is operated periodically.

In a second aspect the present invention consists of a washing apparatus for washing trades equipment, the apparatus comprising:
a supply tank containing a wash fluid in a substantially clean state;
a supply pump for supplying the wash fluid from the supply tank through a first line to at least one nozzle for directing the wash fluid at the equipment;
at least one receptacle for collecting the wash fluid in a contaminated state, the wash fluid being contaminated with waste washed from the equipment;
a collection tank for holding the wash fluid collected by said receptacle, said collection tank positioned substantially above said supply tank and in fluid connection there between via a second line having a first valve; a
dosing device for automatically introducing a coagulant into the wash fluid within said collection tank;
characterised in that a return pump for pumping the contaminated wash fluid and sediment from the collection tank to at least one filter assembly fluidally connected via a third line to said collection tank; and that said return pump cyclically urges said sediment and said wash fluid to said filter assembly, and that under influence of gravity wash fluid passes through said filter assembly and returns to said collection tank, and that an agitator is disposed within said to collection tank for agitating said wash fluid and said sediment and said agitator operable simultaneous with said return pump and an electronic control unit operably connected to said supply pump, return pump, said first valve, and an upper level switch within said collection tank, said electronic control unit comprising a plurality of timers; and when said collection tank is filled and said upper level switch is actuated, both the supply pump and return pump are deactivated for a first period of time to allow wash water in said collection tank under the influence of said coagulant to form relatively clean water above a layer of said sediment, and following said first period of time, said first valve is actuated to open for a second period of time to allow at least portion of said relatively clean water to be discharged under influence of gravity to said supply tank.

Preferably said return pump is periodically actuated by said electronic control unit to flush said third line and provide regular filtration to said wash water.

A washing apparatus for washing trades equipment as claimed in claim 14, wherein said electronic control unit is able to control said apparatus through a first working cycle and second standby cycle.

Preferably an agitator is disposed within said collection tank for agitating said wash fluid and said sediment, said agitator operably connected to said electronic control unit.

In a third aspect the present invention consists of a method of washing trades equipment, the method comprising directing a wash fluid in a substantially clean state, supplied from a supply tank by a first pump through a nozzle, at the equipment, collecting said wash fluid in a contaminated state within a receptacle after the wash fluid has been contaminated with waste washed from the equipment, into a collection tank positioned above said supply tank, said wash fluid in said collection tank dosed by a coagulant, and allowing said wash fluid under influence of said coagulant to separate into relatively clean wash fluid above a layer of sediment in said collection tank, and allowing at least a portion of said relatively clean wash fluid in said collection tank to be discharged into said supply tank under the influence of gravity; and wherein periodically a second pump is used to pump sediment and wash fluid to a filter assembly, and that under the influence of gravity wash fluid passes through said filter assembly thereby by leaving behind a substantially de-watered sediment in said filter assembly.

Preferably an electronic control unit is operably connected to said supply pump, return pump, said first valve, and an upper level switch within said collection tank, and said electronic control unit comprising a plurality of timers, and said electronic control unit controls said apparatus through a first working cycle and second standby cycle.

Preferably when said collection tank is filled and said upper level switch is actuated, both said first pump and said second pump are deactivated for a first period of time to allow wash water in said collection tank under the influence of said coagulant to form relatively clean water above a layer of said sediment, and following said first period of time, said first valve is actuated to open for a second period of time to allow at least portion of said relatively clean water to be discharged under influence of gravity to said first tank.

Preferably said second pump is periodically activated by said electronic control unit to flush the line connecting it to said filter assembly and provide regular filtration to said wash water. Preferably during said second standby cycle, and subsequent to at least portion of said relatively clean water being discharged under influence of gravity to said supply tank, said return pump is periodically operated to pump a slurry of said sediment to said filters, and at a later time said return pump is deactivated to allow for dewatering of the slurry in said filters in order to allow for change of said filters.

Preferably a first dosing pump and said nozzle are both operably connected to said electronic control unit, and when said nozzle is operated to dispense wash fluid said dosing pump is operated to dispense said coagulant to said collection tank.

Preferably a second dosing pump is operably connected to said electronic control unit, and periodically said second dosing pump is operated to dispense a bacteria and enzyme based solution to said supply tank.

Preferably an air pump is operably connected to said electronic control unit, and periodically said air pump is operated to deliver air to said supply tank.

### BRIEF DESCRIPTION OF DRAWINGS

FIG. 1 is a perspective view of a washing apparatus in accordance with the present invention.

FIG. 2 is a plan view of the apparatus shown in FIG. 1.

FIG. 3 is an end view of the washing apparatus shown in FIG. 1.

FIG. 4 is a sectional schematic view through A-A in FIG. 3.

FIG. 5 is a schematic diagram of the washing apparatus shown in FIG. 1.

FIG. 6 is a block diagram of the electronic control unit and the various components it controls of the washing apparatus shown in FIG. 1.

### BEST MODE OF CARRYING OUT THE INVENTION

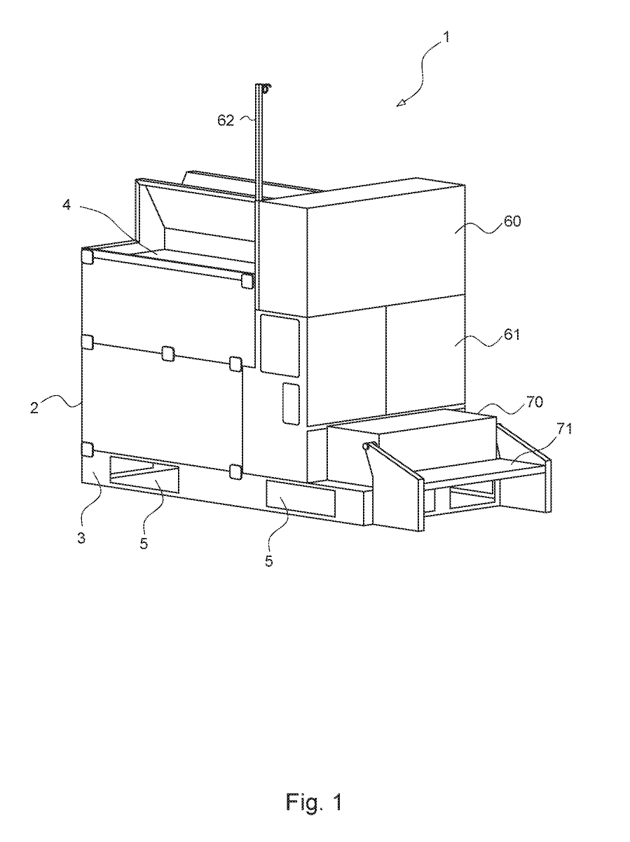

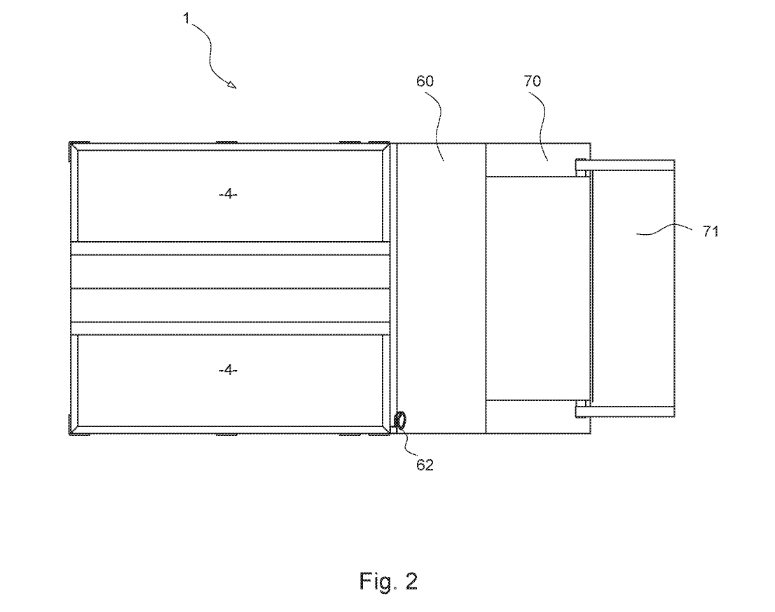

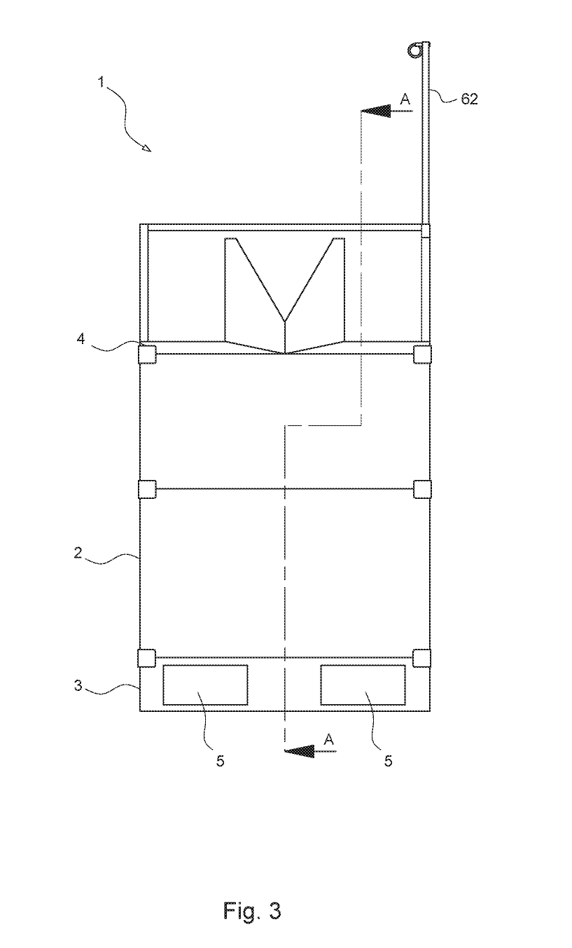

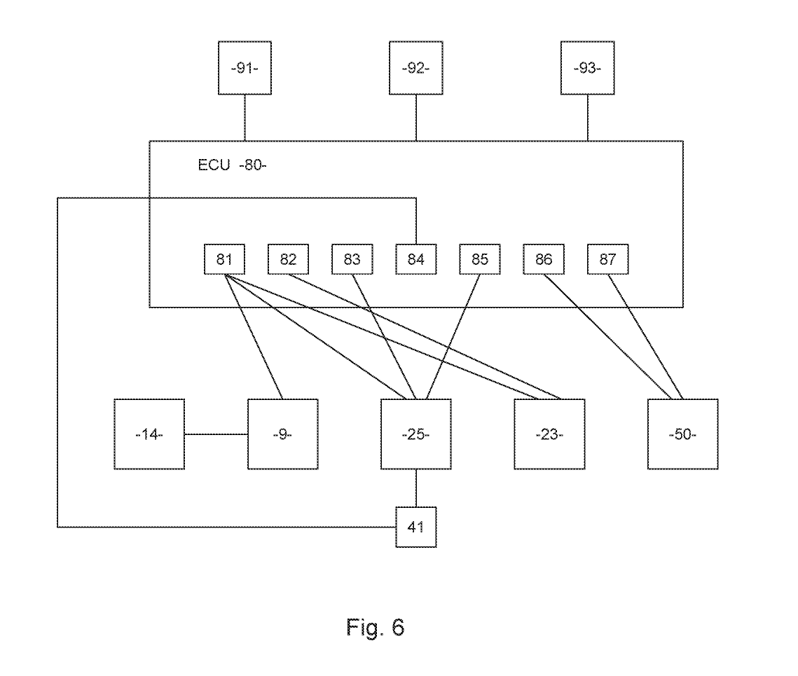

FIGS. 1 to 6 show a preferred embodiment of a washing apparatus 1 in accordance with the present invention. Washing apparatus 1 is particularly suited to washing or cleaning painting equipment, such as paint brushes and rollers, but it may also be used for washing other trades equipment.

Washing apparatus 1 comprises an enclosure 2 mounted on a base 3. Base 3 has openings 5 in its sides to enable a forklift truck to lift and move washing apparatus 1. Enclosure 2 supports a washing receptacle, namely two removable wash trays 4 on opposed sides of apparatus 1. Wash trays 4 are at a height convenient for a person to wash equipment whilst standing. Equipment to be washed is supported by, or held above, a wash tray 4 during washing.

A first reservoir, namely supply (or bottom) tank 7, is located, within the lower half of enclosure 2. Supply tank 7 holds clean wash fluid 8. In this specification, “Clean wash fluid” means that the wash fluid is in a “clean state”. Clean wash fluid 8 is typically substantially clean water or water recycled through washing apparatus 1 in a manner that will be described. In this specification, “substantially clean water” means mains tap water or chemically treated (recycled) water. At the start of the operation of washing apparatus 1, supply tank 7 is filled with clean wash fluid 8, which is usually substantially clean water, from an external source.

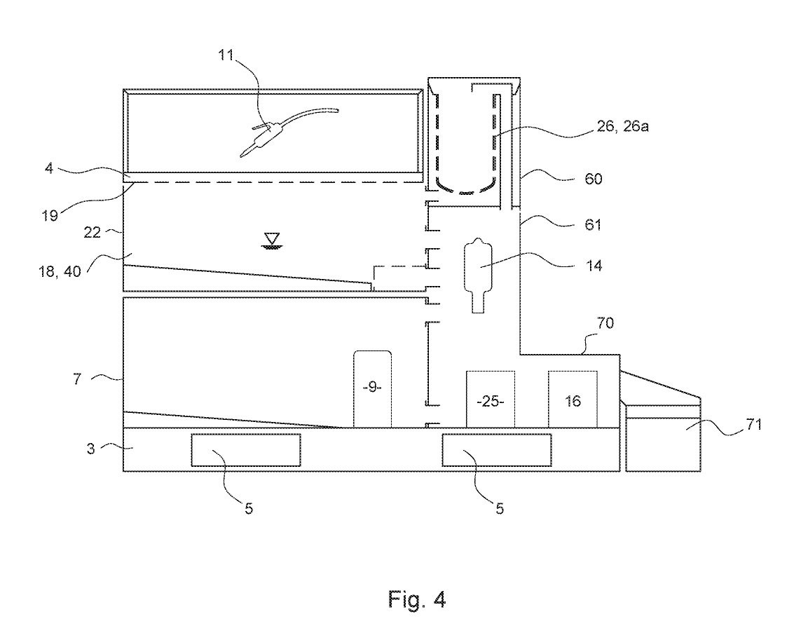

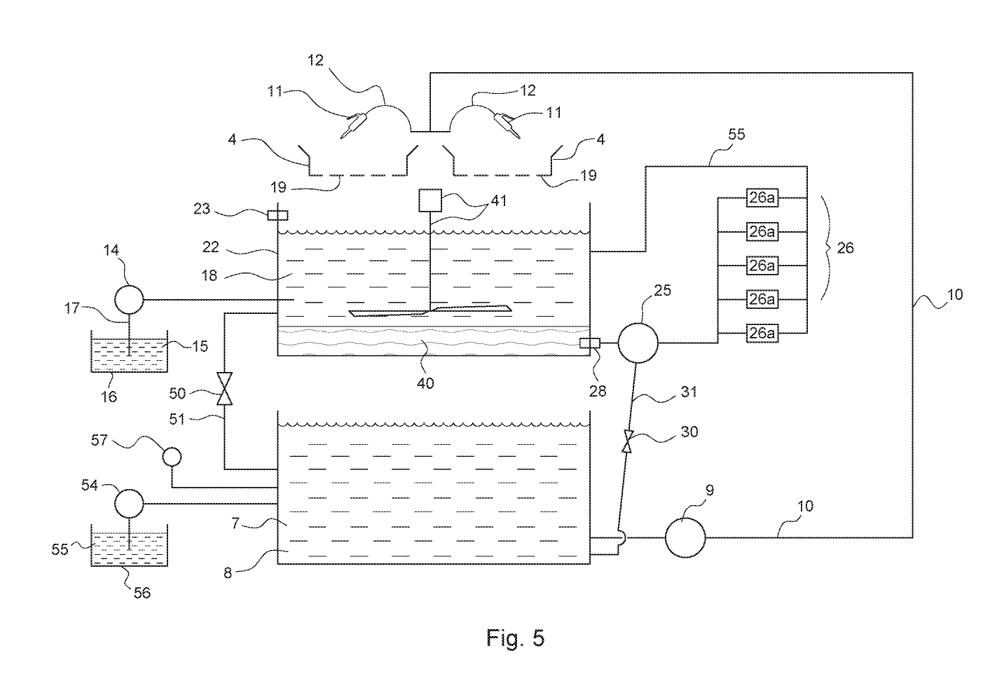

As best seen in FIG. 5, a first pump, namely supply pump 9, delivers clean wash fluid 8 on demand through a supply line 10 to trigger operated delivery nozzles 11. Each trigger nozzle 11 is connected to supply line 10 by a flexible hose 12. Nozzles 11 and flexible hoses 12 are omitted from FIGS. 1-3 for clarity. The power lead for providing power to apparatus 1 is also not shown, but the support pole 62 that supports the power lead is shown in FIGS. 1 to 3. However, support pole 62 is omitted from FIG. 4.

In use, nozzle 11 operated by a user (not shown) directs a stream of clean washing fluid 8 at the equipment being washed. Nozzle 11 is preferably a tapered, low flow nozzle with blade tips that produce a fan like stream of wash fluid 8 that is efficient for washing. Typically, the flow rate through nozzle 11 will be about four litres per minute. Supply pump 9 starts automatically when the trigger of one nozzle 11 is activated by a user.

Once clean wash fluid 8 passes over equipment being washed it becomes contaminated wash fluid 18 that is contaminated with waste washed off the equipment. “Contaminated wash fluid” means that the wash fluid is in a “contaminated state”. The “contaminated wash fluid” is also known as “wash-water” in water based cleaning systems. After it passes over the equipment being washed, the contaminated wash fluid 18 is collected by wash trays 4. Each wash tray 4 includes a removable perforated panel 19 that the contaminated wash fluid 18 passes through. Perforated panels 19 can be used to support equipment being washed and they capture larger solid waste.

The contaminated wash fluid 18 collected by wash tray 4 may preferably pass through a collection filter (not shown) to capture solids or heavier waste in the contaminated wash fluid 18. The collection filter may be disposed within or directly below wash tray 4.

After contaminated wash fluid 18 is collected by wash trays 4, and possibly filtered, it then flows into a second reservoir, namely collection (top) tank 22. Collection tank 22 sits within enclosure 2 at a level above said supply tank 7. Collection tank 22 may include an upper level switch 23 that triggers when the fluid level in collection tank 22 reaches a predetermined upper level, and a lower level switch (not shown) that triggers when the fluid level in collection tank 22 drops to a predetermined lower level.

A dosing pump 14 is used to automatically introduce (dose) a coagulant 15 into contaminated wash fluid 18 in tank 22, every time wash nozzle 11 is operated ie when supply pump 9 delivers clean wash fluid 8 through nozzle 11. Dosing pump 14 draws coagulant 15 from a coagulant reservoir 16 through a tube 17.

Contaminated wash fluid 18 is held in collection tank 22 until “under the influence of coagulant 15” contaminated wash fluid 18 is separated into relatively clean water above a layer of sediment (or sludge) 40. At least a portion of said relatively clean water may be discharged to supply tank 7 via a valve 50 in a second line 51 under the influence of gravity. Relying on the “influence of gravity” for the relatively clean water to be discharged (drained) from collection tank 22 to supply tank 7 has two advantages. Firstly, it eliminates the need to utilise a pump to carry out this task, and secondly if a pump was used it may cause turbulence that would undesirably churn up the layer of sediment, at the time water is being removed from collection tank 22.

A second pump, namely return pump 25, is connected to an outlet 28 near the bottom of collection tank 22. Return pump 25 is able to pump sediment 40, in the form of sludge containing water (wash fluid), from collection tank 22 to a filter assembly (filtration unit) 26. In this embodiment filter assembly 26 is a plurality of filters 26a, fluidally connected via a third line 55 back to collection tank 22. In this embodiment each return filter 26a comprises a twenty-five micron needle felt polyester liquid fabric filter bag.

When sludge (sediment 40 containing wash fluid 18) from collection tank 22 is periodically pumped to filter assembly 26, wash fluid 18 that is in the sludge passes through filter assembly 26 under the influence of gravity thereby, by leaving behind a substantially de-watered sediment in filter assembly 26. An advantage of this arrangement is that should any waste pass through filter assembly 26, it returns to collection tank 22. This is important because the abovementioned filter bags when new, have a tendency to allow fine waste particles to pass through until a sediment film builds up on them.

In normal use of wash apparatus 1, the sediment (sludge) 40 remaining in filter assembly 26 will dry out over time, so that typically some 70-80% of the water (wash fluid 18) in that sludge has been removed and most of it returned to collection tank 22. Advantageously this significantly reduces the weight of the sludge, thereby making it easier to handle for disposal. Furthermore returning water (wash fluid 18) removed via filter assembly 26 to collection tank 22 rather than supply tank 7, is to ensure that if any spillage of sediment/sludge occurs due to damage or failure of filters 26a, then such contaminant will return to collection tank 22. Also in normal use of wash apparatus 1, it would be necessary to periodically remove the sludge from filter assembly 26, and check filters 26a for maintenance and/or replacement. This could for instance be conducted on a weekly or bi-weekly basis, but more preferably on a daily basis.

Supply tank 7 is connected to return pump 25 via a valve 30 in a third line 31. As such return pump 25 can be used if necessary to pump water in supply tank 7 through filter assembly 26 to collection tank 22. This may be necessary should water in supply tank 7 become contaminated or for maintenance reasons.

Filter assembly 26 is housed in upper cabinet 60, whilst pumps 9 and 25 and dosing device 14 and coagulant reservoir 16 are housed in lower cabinet 61.

As washing apparatus 1 relies on the influence of gravity for wash fluid that is in the sludge to pass through filter assembly 26, the location of the filter assembly 26 (and therefore filters 26a) must be at a height above collection tank 22. In this embodiment it would be difficult for an average height maintenance man to access filter assembly 26 from above when standing on the ground. As such, apparatus 1 has a platform 70 and pivotal step 71. As shown in FIG. 1, step 71 is in the “in-use configuration” allowing a user (not shown) to use step 71 to reach and stand on platform 70, so as to easily access filter assembly 26. When step 71 is not in-use, it can be pivoted so that it can be placed in a “stowed configuration”, out of the way above platform 70.

Washing apparatus 1 has an electronic control unit (ECU) 80 comprising seven timers 81-87. ECU 80 is operably connected to supply pump 9, return pump 25, valve 50 and valve 30, and upper level switch 23 and lower level switch (not shown). ECU 80 may be used to control the the automated “working cycle” and “standby cycle” of washing apparatus 1. Supply pump 9, return pump 25, and valve 50 can also be turned on and off manually by manual switches (not shown) associated therewith.

Dosing pump 14 is operably connected to supply pump 9 (either directly thereto or via ECU 80), so that when supply pump 9 is delivering wash fluid to nozzles 11, dosing pump 14 is also activated to deliver coagulant 15 to collection tank 22.

Collection tank 22 has an automatic electrically powered agitator (stirrer) 41, to stir wash fluid 18 also connected. This happens periodically as controlled by timer 84 of ECU 80. It has the effect of keeping heavy waste suspended (forming a suspension of the waste within wash fluid 18). This means more of the heavier waste can be removed by return pump 25 and sent to filter assembly 26. The agitator 41 also aids with the mixing of the dosed coagulant 15 within wash fluid 18. The coagulation works better in a stirred tank. Each time ECU 80 activates the pumping process of wash fluid 18 via return pump 25 to filter assembly 26, agitator 41 will be simultaneously activated. In addition, agitator 41 will preferably run periodically on its own by a timer 88 in ECU 80, to keep the waste suspended in the wash fluid 18, and thereby minimize it forming into sediment on the bottom of collection tank 22.

There is also provided a second dosing pump 54, which periodically doses a solution 55 from a reservoir 56 to supply tank 7, and an air pump 57 for pumping air into supply tank 7. The solution 55 and air via air pump 57 being delivered to supply tank 7 is for maintaining water quality. Solution 55 may for example be a “bacteria and enzyme” based solution, which together with air (containing oxygen) being delivered via air pump 57 work to remove odour causing bad bacteria from supply tank 7. Solution 55 may for example be a “bacteria and enzyme” based formulation marketed under the brand Effluent Care M100P, which is dosed to water supply tank 7 every couple of days.

Preferably on the back of apparatus at the top of supply tank 7, there is a “cut-out with a lockable cover” (not shown). When the lockable cover is removed, access is provided to the supply tank 7 area for the purpose of removing any slurry waste contamination that may have been deposited there over time by the process. Through this access cut-out waste build-up from the bottom of supply tank 7 can be removed by connecting a hose to return pump 25, and using the suction from this pump to clean supply tank 7 and deposit the waste into the filter bags of filter bag assembly 26 for removal from the system.

### Working Cycle

The “working cycle” can be set to start and finish at any time depending on whether washing apparatus 1 is being used for a dayshift or night shift, short or extended shift.

During the working cycle a timer 83 allows power to return pump 25 during the designated working hours, and timer 85 preferably controls a short cycle, say a one minute cycle, of return pump 25 every hour for the purpose of flushing the lines and providing regular filtration of wash fluid 18 in a contaminated state within collection tank 22, during which time return pump 25 will pump approximately one-seventh ( 1/7^{th}) of contaminated wash fluid 18 through filter assembly 26. During these times there is a “white” first light 91 illuminated on washing apparatus 1 to indicate that it can be used.

During the “working cycle” there is also a timer 81 and timer 82, connected to upper level switch 23 that cuts off power to supply pump 9 and return pump 25 when collection tank 22 reaches its capacity. At this time a “red” second light 92 on washing apparatus 1 is illuminated to indicate that it cannot be used at this time. The power is cut off for a period of time, say approximately fifteen minutes, to allow sediment 40 and water 18 in collection tank 22 to separate with the aid of coagulant 15 that has been added to fluid 18 as part of the washing process. Just before the end of this fifteen minute period, timer 87 opens valve 50 between the collection tank 22 and supply tank 7 for a short period of time, say approximately three minutes, to allow the relatively clean water to be returned to supply tank 7 under gravity. During this time an “orange” third light 93 and white first light 91 are illuminated to indicate that washing apparatus will be available in a short period of time, say three minutes. At high level during the working cycle, after relatively clean water is drained back under gravity to supply tank, return pump 25 activates for one minute to evacuate settled waste to filters 26a prior to the apparatus 1 being ready for use.

### Standby Cycle

A “standby cycle” is usually set to start at the end of the working shift and to carry on until approximately four hours prior to the commencement of the next working shift. This allows time for substantial dewatering of any waste in the filter assembly 26 to occur in case filters 26a require changing.

During the “standby cycle” timer 83 allows power to return pump 25 during the designated standby hours, and timer 85 controls a short cycle, say a one minute cycle, of return pump 25 every hour for the purpose of flushing the lines and providing regular filtration of wash fluid 18 in a contaminated state within collection tank 22, during which time return pump 25 will pump approximately one-seventh ( 1/7^{th}) of contaminated wash fluid 18 through filter assembly 26.

At a designated time, timer 86 opens valve 50 between collection tank 22 and supply tank 7 for a short period of time, say approximately three minutes, to allow the relatively clean water to be returned to supply tank 7 under gravity.

Return pump 25 then continues to cycle every hour, still controlled by timers 83 and 85, pumping what is now only the remaining concentrated slurry through filters 26a of filter assembly 26.

At a designated time, timer 83 will cut-off (deactivate) power to return pump 25 to allow time for dewatering of the waste in the filters 26a to enable filter change prior to commencement of the working cycle.

The abovementioned ECU 80 may preferably be in the form of a programmable logic controller (PLC). Electronic control unit 80 may preferably be provided with a “not shown” removable touch screen. The touch screen is used to adjust the sequence and timing to the program that runs the process that is embedded in ECU 80. Key metrics involved in the process and use of apparatus 1, such as the run times of the pumps, the high and low levels in the tanks, and alarms such as pump failure or errors in the process may be recorded in ECU 80. Preferably this key metric “information” could be accessed remotely from ECU 80 via the internet or other telecommunication network to provide real time usage and data to the users.

In an alternative not shown embodiment pivotal step 71 is replaced by a removable step, removably attached to apparatus 1 by a plurality of screws. The removable step may also be enclosed so that it acts as a storage area for solutions that are dosed into apparatus 1.

In summary some of the advantages that the abovementioned embodiment has over the prior art is as follows:
the collection tank being situated above the supply tank, allows for relatively clean (treated water) to be discharged under “the influence of gravity”, thus eliminating the need of a pump to carry out this task, and by eliminating such pump the likelihood of churning up sediment is eliminated when transferring water from collection tank 22 to supply tank 7;
the use of a coagulant 15 dosed into collection tank 22, in combination with the periodic stirring (agitation) by agitator 41, not only aids the mixing of coagulant 15 into wash fluid 18, but ensures that heavy waste is suspended within wash fluid 18, thereby making it easier to have the heavy waste pumped by return pump 25 to filter assembly 26;
the waste that is settled out or captured in filters 26a is substantially dewatered, thereby making it easier to handle for disposal, and can be done by a worker on site, rather than by an external contractor;
as the waste in filters 26a is substantially dewatered, and such water is returned to collection tank 22, there is no need to discharge any fluid to the sewer or any slurry waste to a receptacle, as such wash apparatus 1 can be more freely located near the area of work on a work site, and if necessary left there for extended periods; and
wash apparatus 1 is operating in a fully automated state, except for the manual emptying of the filters 26a, thus making it easy to use.

The terms “comprising” and “including” (and their grammatical variations) as used herein are used in an inclusive sense and not in the exclusive sense of “consisting only of”.

1. A washing apparatus for washing trades equipment, the apparatus comprising:
a supply tank containing a wash fluid in a substantially clean state;
a supply pump for supplying the wash fluid from the supply tank through a first line to at least one nozzle for directing the wash fluid at the equipment;
at least one receptacle for collecting the wash fluid in a contaminated state, the wash fluid being contaminated with waste washed from the equipment;
a collection tank for holding the wash fluid collected by said receptacle, said collection tank positioned substantially above said supply tank and in fluid connection there between via a second line having a first valve;
a dosing device for automatically introducing a coagulant into the wash fluid within said collection tank; and
a return pump for pumping the contaminated wash fluid and sediment from the collection tank to at least one filter assembly fluidally connected via a third line to said collection tank, characterised in that an agitator is disposed within said collection tank for agitating said wash fluid and said sediment, said return pump cyclically urges said sediment and contaminated wash fluid to said filter assembly, and that under the influence of gravity wash fluid passes through said filter assembly and returns to said collection tank thereby leaving behind a substantially de-watered sediment in said filter assembly, and once said wash water in said collection tank has under the influence of said coagulant formed relatively clean water above a layer of said sediment, at least portion of said relatively clean water may be discharged under influence of gravity to said supply tank via said first valve in said second line.

2. A washing apparatus as claimed in claim 1, wherein said supply tank is fluidally connected to said return pump via a fourth line having a second valve so that wash water in said supply tank can be pumped through said filter assembly.

3. A washing apparatus for washing trades equipment as claimed in claim 1, wherein said filter assembly is disposed at a location above said collection tank, and said apparatus comprises a platform and a step which allows a user to step up to said platform and access said filter assembly.

4. A washing apparatus for washing trades equipment as claimed in claim 1, wherein an electronic control unit operably connected to said supply pump, return pump, said first valve, and an upper level switch within said collection tank, said electronic unit comprising a plurality of timers.

5. A washing apparatus for washing trades equipment as claimed in claim 1, wherein when said collection tank is filled and said level switch is actuated, the power to both said supply pump and said return pump is cut-off for a first period of time to allow wash water in said collection tank under the influence of said coagulant to form relatively clean water above a layer of said sediment, and following said first period of time, said first valve is electronically actuated to open for a second period of time to allow at least portion of said relatively clean water to be discharged under influence of gravity to said supply tank.

6. A washing apparatus for washing trades equipment as claimed in claim 4, wherein said return pump is periodically actuated by said electronic control unit to flush said third line and provide regular filtration to said wash water.

7. A washing apparatus for washing trades equipment as claimed in claim 4, wherein said electronic control unit is able to control said apparatus through a first working cycle and second standby cycle.

8. A washing apparatus for washing trades equipment as claimed in claim 7, wherein said washing apparatus comprises a first visual indicator, a second visual indicator and a third visual indicator, all operably connected to said electronic control unit, said first visual indicator for indicating that said apparatus may be used during said working cycle, said second visual indicator for indicating that said apparatus cannot be used during said work cycle as said collection tank is full.

9. A washing apparatus as claimed in claim 7, wherein during said second standby cycle, and subsequent to at least portion of said relatively clean water being discharged under influence of gravity to said supply tank, said return pump is periodically operated to pump a slurry of said sediment to said filters, and at a later time said return pump is deactivated to allow for dewatering of the slurry in said filters in order to allow for change of said filters.

10. A washing apparatus as claimed in claim 1, wherein said agitator is operated simultaneously with said return pump.

11. A washing apparatus as claimed in claim 1, wherein said agitator is operated periodically.

12. A washing apparatus for washing trades equipment, the apparatus comprising:
a supply tank containing a wash fluid in a substantially clean state;
a supply pump for supplying the wash fluid from the supply tank through a first line to at least one nozzle for directing the wash fluid at the equipment;
at least one receptacle for collecting the wash fluid in a contaminated state, the wash fluid being contaminated with waste washed from the equipment;
a collection tank for holding the wash fluid collected by said receptacle, said collection tank positioned substantially above said supply tank and in fluid connection there between via a second line having a first valve;
a dosing device for automatically introducing a coagulant into the wash fluid within said collection tank;
characterised in that a return pump for pumping the contaminated wash fluid and sediment from the collection tank to at least one filter assembly fluidally connected via a third line to said collection tank and that said return pump cyclically urges said sediment and said wash fluid to said filter assembly, and that under the influence of gravity wash fluid passes through said filter assembly and returns to said collection tank, and that an agitator is disposed within said collection tank for agitating said wash fluid and said sediment and said agitator operable simultaneous with said return pump and an electronic control unit operably connected to said supply pump, return pump, said first valve, and an upper level switch within said collection tank, said electronic control unit comprising a plurality of timers;
and when said collection tank is filled and said upper level switch is actuated, both the supply pump and return pump are deactivated for a first period of time to allow wash water in said collection tank under the influence of said coagulant to form relatively clean water above a layer of said sediment, and following said first period of time, said first valve is actuated to open for a second period of time to allow at least portion of said relatively clean water to be discharged under influence of gravity to said supply tank.

13. A washing apparatus for washing trades equipment as claimed in claim 12, wherein said return pump is periodically actuated by said electronic control unit to flush said third line and provide regular filtration to said wash water.

14. A washing apparatus for washing trades equipment as claimed in claim 12, wherein said electronic control unit is able to control said apparatus through a first working cycle and second standby cycle.

15. A washing apparatus as claimed in claim 12, wherein an agitator is disposed within said collection tank for agitating said wash fluid and said sediment, said agitator operably connected to said electronic control unit.

16. A method of washing trades equipment, the method comprising directing a wash fluid in a substantially clean state, supplied from a supply tank by a first pump through a nozzle, at the equipment, collecting said wash fluid in a contaminated state within a receptacle after the wash fluid has been contaminated with waste washed from the equipment, into a collection tank positioned above said supply tank, said wash fluid in said collection tank dosed by a coagulant, and allowing said wash fluid under influence of said coagulant to separate into relatively clean wash fluid above a layer of sediment in said collection tank, and allowing at least a portion of said relatively clean wash fluid in said collection tank to be discharged into said supply tank under the influence of gravity; and wherein periodically a second pump is used to pump sediment and wash fluid to a filter assembly, and that under the influence of gravity wash fluid passes through said filter assembly and returns to said collection tank thereby by leaving behind a substantially de-watered sediment in said filter assembly, and an agitator is disposed within said collection tank that is simultaneously operated with said second pump for agitating said wash fluid and said sediment.

17. A method as claimed in claim 16, wherein an electronic control unit is operably connected to said supply pump, return pump, said first valve, and an upper level switch within said collection tank, and said electronic control unit comprising a plurality of timers, and said electronic control unit controls said apparatus through a first working cycle and second standby cycle.

18. A method as claimed in claim 17, wherein when said collection tank is filled and said upper level switch is actuated, both said first pump and said second pump are deactivated for a first period of time to allow wash water in said collection tank under the influence of said coagulant to form relatively clean water above a layer of said sediment, and following said first period of time, said first valve is actuated to open for a second period of time to allow at least portion of said relatively clean water to be discharged under influence of gravity to said first tank.

19. A method as claimed in claim 17, wherein said second pump is periodically activated by said electronic control unit to flush the line connecting it to said filter assembly and provide regular filtration to said wash water.

20. A method as claimed in claim 17, wherein during said second standby cycle, and subsequent to at least portion of said relatively clean water being discharged under influence of gravity to said supply tank, said return pump is periodically operated to pump a slurry of said sediment to said filters, and at a later time said return pump is deactivated to allow for dewatering of the slurry in said filters in order to allow for change of said filters.

21. A method as claimed in claim 16, wherein a first dosing pump and said nozzle are both operably connected to said electronic control unit, and when said nozzle is operated to dispense wash fluid said dosing pump is operated to dispense said coagulant to said collection tank.

22. A method as claimed in claim 16, wherein a second dosing pump is operably connected to said electronic control unit, and periodically said second dosing pump is operated to dispense a bacteria and enzyme based solution to said supply tank.

23. A method as claimed in claim 22, wherein an air pump is operably connected to said electronic control unit, and periodically said air pump is operated to deliver air to said supply tank.
